(19) United States
(12) Patent Application Publication
(10) Pub. No.: US 2005/0082016 A1
(43) Pub. Date: Apr. 21, 2005

(54) Window blind

(76) Inventor: Cheng-Hsiung Su, Foshan City (CN)

Correspondence Address: Richard P. Berg, ESQ;c/o LADAS & PARRY, Suite 2100, 5670 Wilshire Boulevard, Los Angeles, CA, 90036-5679, US

(21) Appl. No.: 10/895,021

(22) Filed: Jul. 19, 2004

(30) Foreign Application Priority Data
Oct. 20, 2003 (CN) 200320101454.5
Oct. 20, 2003 (CN) 200320101453.0
Oct. 20, 2003 (CN) 200320101452.6

(51) Int. Cl. E06B 9/26

(52) U.S. Cl. 160/166.1

(57) ABSTRACT

A window blind comprises a headrail, a bottomrail and a plurality of slats, whereof the main body of the headrail is a approximate U-shaped channel, a plurality of strengthening ribs are longitudinally placed on the bottom of the channel, the rear wall and bottom of which are flat, the front wall is a V-shaped plate with a folded angle protruding outwards, underside of which being provided with holes to mount lift cords and tilt rod, the slat is W-shaped long slat, the bottomrail is an symmetrical flat tube with a flat bottom, two arc-shaped side walls and a top plane with a longitudinal groove. The window blind elegantly shaped can blind light effectively and with a high transverse stiffness, thus it is robust.

### BACKGROUND OF THE INVENTION

(a) Technical Field of the Invention

This invention relates to a window blind.

(b) Description of the Prior Art

A window blind comprises a headrail, a bottomrail which may help to hold and stabilize the window blind, and a plurality of slats, wherein a tilt and lift device connected to the slats and the bottomrail through route cords is placed in the headrail.

The main body of the existing headrail of a window blind is an elongate U-shaped channel, of which the both side walls and the bottom are all planar. There are hems on both sides of the slotted top surface. The hems connect to the side walls respectively. The configuration has a disadvantage that the headrail has a poor transverse stiffness so that it is easy to be damaged.

The existing slats of a window blind are elongate strips made of plastic or metal plate, and the cross section of each slat is arc-shaped. This kind of slat has a poor transverse stiffness so that it is easy to be damaged, moreover it can't blind light effectively.

The existing bottomrail of a window blind is a flat tube with curved sides. This configuration has a drawback that the bottomrail has a poor transverse stiffness so that it is easy to be damaged. To address this problem, it can be envisaged that the transverse stiffness may be increased by means of enlarging the cross section area, but it wastes material and has negative effect on the elegance of the window blind.

### SUMMARY OF THE INVENTION

An object of the present invention is to provide a headrail with an improved transverse stiffness so that the headrail is robust.

A further object of the present invention is to provide a slat with an improved transverse stiffness so that the slat may blind light more effectively.

A further object of the present invention is to provide a bottomrail with an improved transverse stiffness so that the bottomrail is not only elegant but also robust.

The above objects are achieved by providing a window blind comprising a headrail, a bottomrail, a plurality of slats, and a tilt and lift device connected with the slats and the bottomrail through corresponding cords, the tilt and lift device is placed in the headrail. The main body of the headrail is in the form of an approximately U-shaped channel with longitudinal strengthening ribs on the flat bottom.

Each slat may be an elongate folded plate, of which the cross sectional configuration is in the form of a folded line with several folded angles, each folded angle turns conversely to the adjacent one.

The bottomrail is in the form of a flat tube with a straight groove extending longitudinally on the top.

Due to the existence of the strengthening ribs on the bottom of the headrail main body of the window blind, the transverse stiffness of the headrail is improved so that its lifespan is prolonged.

Due to the configuration of the angles, the transverse stiffness of each slat is improved and it can be overlapped together, so that it can blind light more effectively, and the slat becomes more elegant.

Due to the strengthening groove placed on the top of bottomrail, the stiffness and lifespan of the bottomrail are improved, moreover, the area of the cross section may be reduced, in that way, the bottomrail becomes more elegant and material may be saved.

### BRIEF DESCRIPTION OF THE DRAWINGS

FIG. 1 is a schematic diagram of a window blind according to the present invention.

FIG. 2 is a schematic perspective view of a headrail.

FIG. 3 is a schematic cross section view of the main body of the headrail in FIG. 3.

FIG. 4 is a schematic perspective view of a slat.

FIG. 5 is a schematic cross section view of the slat in FIG. 4.

FIG. 6 is a schematic perspective view of a bottomrail.

FIG. 7 is a schematic cross section view of bottomrail in FIG. 6.

### DETAILED DESCRIPTION OF THE PREFERRED EMBODIMENT

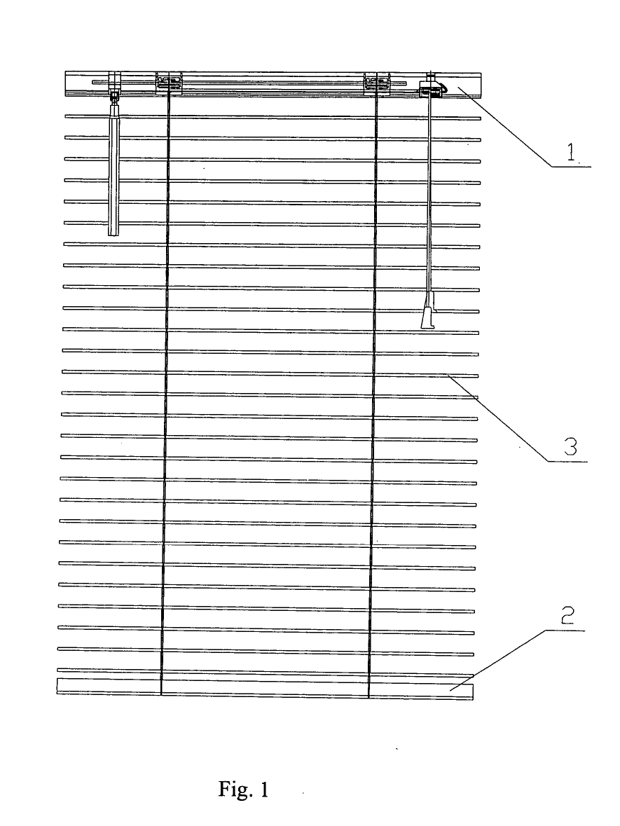

As shown in FIG. 1, a window blind according to the present invention comprises a headrail 1, a bottomrail 2, a plurality of W-shaped slats 3, and a tilt and lift device connected with the slats and the bottomrail through corresponding cords, wherein the tilt and lift device is placed in the headrail.

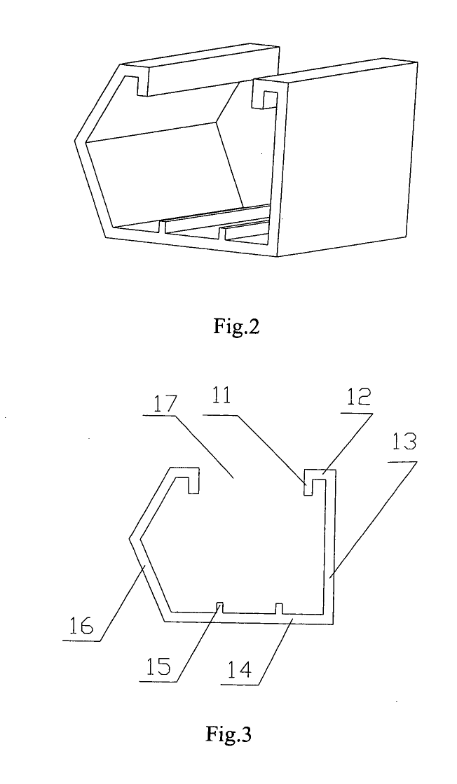

As shown in FIG. 2, 3, the main body of the headrail 1 is in the form of an approximately U-shaped channel, of which the bottom surface 14 is flat with longitudinal strengthening ribs 15 thereof.

Preferably, there are two strengthening ribs, and each rib is a stripe extending longitudinally.

The rear wall 13 of the main body of the headrail may be planar, and the horizontal top surface 12 is connected to the front wall 16 and the rear wall 13, which may be placed on the both sides of a slot 17 on the top plane of the headrail. The front wall may be a V-shaped plate with a certain folded angle protruding outwards.

Preferably, vertical hems 11 extending to the channel can be set on the flanges of the top surface 12 so that the vertical hems can also strengthen the headrail.

The holes used to mount lift cords and tilt rod may be set in the lower section of the front wall of the headrail. Due to the front wall protruding outwards, the cords and the tilt rod keep a certain distance with the slats, so that they can be operated without interfere with the slats.

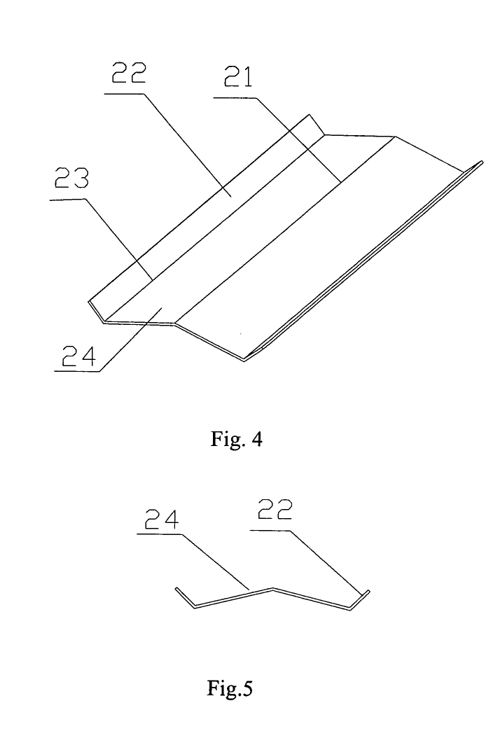

As shown in FIGS. 4 and 5, the slat 3 is an elongated folded plate, of which the cross sectional configuration is a broken line with several folded angles, each folded angle turns conversely to the adjacent one.

Generally, the slat is a W-shaped plate with three folded angles, wherein the middle folded angle turns conversely to the two side folded angles.

Generally, in order to reduce the overlap of the slats in order to save material, the width of the side hems 22 placed on both sides of a slat 3 is shorter than that of the middle flange 24 placed on the middle of the slat 3, as the former is corresponding to the overlap length.

For the compactness of the overall window blind, the vertex of the middle angle 21 is placed in the middle of a slat and the ends of side hems 22 of the slat are set in the same plane which is parallel to a plane including the vertexes of the side angles 23. In this case, the middle angle 21 should be larger than that of the side angles.

Generally, the slats are symmetrical.

The hems 22, 24 are the planar parts between any two adjacent vertexes of any angle (22, 23) or the planar parts outside the outmost vertex of side angles.

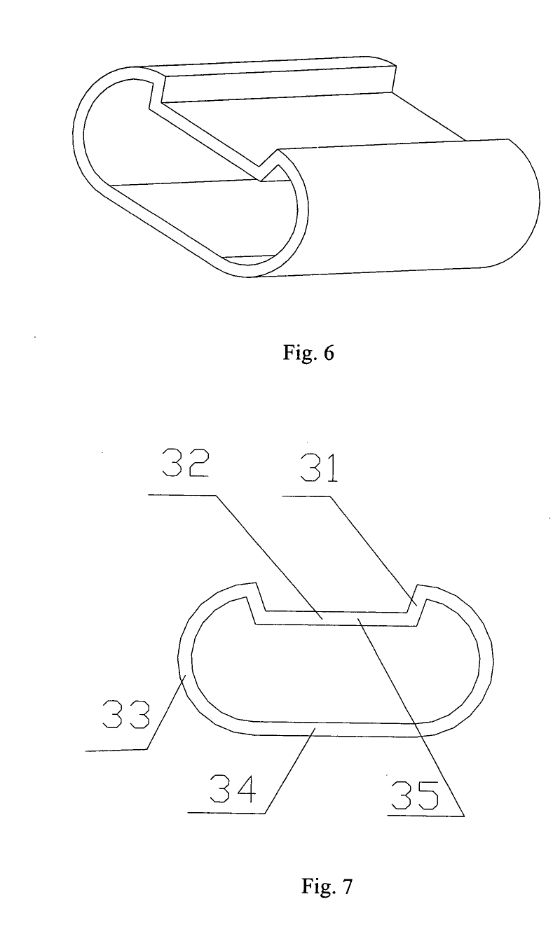

As shown in FIGS. 6 and 7, the bottomrail 3 is a flat tube, with a straight groove 32 on the top plane.

Both the side walls 31 and the bottom of the straight groove 32 may be planar and the side walls 31 may be placed vertically or aslant to the bottom.

The bottom 35 of the groove may also be planar.

The bottom 34 of the bottomrail 2 may be planar, in this case, it will be elegant, easy to be produced and used.

Both of the side walls 33 of the bottomrail 2 may be arc-shaped, and may smoothly connect with the outer surface of the bottom of the bottomrail.

The straight groove may occupy the overall top plane of the bottomrail.

Alternatively, the straight groove can also be positioned in the middle of the top plane of the bottomrail.

The bottom rail is symmetrical, and its thickness is typically consistent.

1. A window blind comprising:
a headrail (1), the main body of which is in the form of an U-shaped channel with a flat bottom (14) with several longitudinal strengthening ribs (15);
a bottomrail (2);
a plurality of W-shaped slats (3); and
a tilt and lift device connected with the slats (3) and the bottomrail (2) through corresponding cords, said tilt and lift device is placed in the headrail (1).

2. A window blind according to claim 1, wherein the headrail (10) comprises:
a flat rear wall (13),
a V-shaped front wall (16) with a folded angle protruding outwards, and
a pair of top walls (12) connecting with the rear wall (13) and the front wall (16) respectively, each of the top walls (12) comprises a vertical hem (11) extending inwards.

3. The window blind according to claim 2, wherein the holes used to mount lift cords and tilt rod are set in the lower position of the front wall of the headrail, and there are two stripe-shaped strengthening ribs (15) extending longitudinally on the flat bottom of the headrail (1).

4. The window blind according to claim 1, wherein each slat (3) is an elongated folded plate with corrugated strip slat, the cross sectional configuration of which is a broken line with several folded angles, each folded angle turns conversely to the adjacent one.

5. The window blind according to claim 4, wherein each slat (3) is symmetrical.

6. The window blind according to claim 5, wherein the cross sectional configuration of each slat (3) is W-shaped plate with side hems (22) shorter than middle hems (24), the vertex of the middle angle (21) positioned in the middle of a slat (3) and the ends of the side hems (22) of the slat (3) are set in a plane which is parallel to a plane including the vertexes of the side angles (23), thus the angle of middle folded angle (21) should be larger than that of the sides folded angles (23).

7. A window blind according to claim 1, wherein the bottomrail (2) is a flat tube with a straight groove extending longitudinally.

8. A window blind according to claim 7, wherein both of the two side walls (31) and the bottom (35) of the straight groove are planar.

9. A window blind according to claim 7, wherein the bottom (34) of the bottom rail (2) is planar while the two sides (33) of the bottomrail (2) is arc-shaped.

10. A window blind according to claim 7, wherein the cross sectional configuration of the bottomrail (2) is symmetrical, and its thickness is consistent; and the straight groove is positioned on the overall top of the bottomrail (2), or on the middle of the top plane of the bottomrail (2).
